(19) United States
(12) Patent Application Publication
(10) Pub. No.: US 2025/0108446 A1
(43) Pub. Date: Apr. 3, 2025

(54) WELD RECORDING SYSTEMS INCLUDING CAMERA FOCUS INDICATORS AND FOCAL POINT ADJUSTMENT

(71) Applicant: Illinois Tool Works Inc., Glenview, IL (US)

(72) Inventor: Nishank Patel, Chicago, IL (US)

(21) Appl. No.: 18/903,241

(22) Filed: Oct. 1, 2024

Related U.S. Application Data
(60) Provisional application No. 63/587,315, filed on Oct. 2, 2023.

(51) Int. Cl. B23K 9/095

(52) U.S. Cl. CPC B23K 9/0956

(57) ABSTRACT

Disclosed example weld monitoring systems include: a camera having a field of view and configured to capture images of the field of view of the camera; a light source coupled to the camera and configured to project a visible indicator onto an object that is within the field of view of the camera, such that the visible indicator at least partially overlaps the field of view of the camera; and communication circuitry configured to transmit data representative of the images.

### RELATED APPLICATIONS

The present application claims the benefit of U.S. Provisional Patent Application Ser. No. 63/587,315, filed Oct. 2, 2023, entitled “WELD RECORDING SYSTEMS INCLUDING CAMERA FOCUS INDICATORS AND FOCAL POINT ADJUSTMENT.” The entirety of U.S. Provisional Patent Application Ser. No. 63/587,315 is expressly incorporated herein by reference.

### FIELD OF THE DISCLOSURE

This disclosure relates generally to weld monitoring and, more particularly, to weld recording systems including camera focus indicators and focal point adjustment.

### BACKGROUND

Recording production weld data allows a production supervisor to monitor the productivity and quality of both automated and manual welding operations. Data recording and monitoring may include collecting data in welding equipment, sending it to the cloud, and retrieving by web browser. Such data may include, for example, a video recording of welding operation which may be useful to fabrication shop supervisors, quality assurance (QA) or quality control (QC) personnel, maintenance personnel, training personnel, and/or the like. In manual welding quality control, video recordings may, for example, be valuable in Failure Mode and Effects Analysis (FMEA) in lean manufacturing.

Weld recording also provides welding instructors an opportunity to observe how a student positions and moves the torch while welding. If, for example, a welding instructor or manager is asked to help a student or production operator, it is a challenge to squeeze in two welding helmets for an observer to view the arc together with the operator due to physical constraints.

### SUMMARY

Weld recording systems including camera focus indicators and focal point adjustment, substantially as illustrated by and described in connection with at least one of the figures, as set forth more completely in the claims.

### BRIEF DESCRIPTION OF THE DRAWINGS

FIG. 1 shows an example arc welding system including weld monitoring cameras, in accordance with aspects of this disclosure.

FIG. 2 shows an example implementation of the welding equipment of FIG. 1.

FIG. 3A illustrates an example welding headwear that may implement the welding headwear of FIG. 1 to record a weld.

FIG. 3B illustrates an example welding camera that may implement the camera(s) of FIG. 1 to record a weld.

FIG. 4 is a block diagram of an example implementation of the example welding headwear and/or the example welding camera of FIGS. 3A and 3B.

FIGS. 5A illustrates an example object within the field of view of the camera of the example welding headwear and/or the example welding camera of FIGS. 3A, 3B, and/or 4, and including a visible laser point indicator of a field of view of the camera.

FIGS. 5B illustrates the example object within the field of view of the camera of the example welding headwear and/or the example welding camera of FIGS. 3A, 3B, and/or 4, and including a visible light beam indicator of a field of view of the camera.

FIGS. 5C-5E illustrate the example object within the field of view of the camera of the example welding headwear and/or the example welding camera of FIGS. 3A, 3B, and/or 4, and including a visible indicator of a field of view and focal distance of the camera.

FIG. 6 is a flowchart representative of example machine readable instructions which may be implemented by the welding headwear and/or the welding camera of FIGS. 3A, 3B, and/or 4 to record a welding-type operation using a camera.

FIG. 7 is a flowchart representative of example machine readable instructions which may be implemented by the welding headwear and/or the welding camera of FIGS. 3A, 3B, and/or 4 to adjust a focal distance of the camera.

FIG. 8 is a block diagram of an example implementation of the computing device of FIG. 1.

The figures are not necessarily to scale. Where appropriate, similar or identical reference numbers are used to refer to similar or identical components.

### DETAILED DESCRIPTION

Conventional camera-integrated welding helmets allow recording and remote viewing of welding. However, conventional camera-integrated welding helmets do not provide a way for the welder to efficiently understand the positioning of the camera with respect to the objects to be recorded. When weld operators are welding, they are unable to see where the camera is recording, as cameras can have a limited field of view relative to the field of view of the welding helmet. Furthermore, conventional camera-integrated welding helmets have significant weight, cost, and/or battery life demands given the amount of data recorded and image processing performed.

Disclosed weld recording systems provide visible indicators to enable welders to quickly understand the field of view and/or focus of the camera to enable ease of positioning. In some examples, distance sensors can be used to improve focal adjustment of the camera, calibration, and/or calculation of metrics that may be used to process the images. In some disclosed examples, weight, cost, and/or battery demands of the weld recording system are reduced by transmitting raw image data to an external computing device for processing, analysis, and/or display.

As used herein, the term “welding operation” includes both actual welds (e.g., resulting in joining, such as welding or brazing) of two or more physical objects, an overlaying, texturing, and/or heat-treating of a physical object, and/or a cut of a physical object) and simulated or virtual welds (e.g., a visualization of a weld without a physical weld occurring).

As used herein, a “welding-type power source” refers to any device capable of, when power is applied thereto, supplying welding, cladding, plasma cutting, induction heating, laser (including laser welding, laser hybrid, and laser cladding), carbon arc cutting or gouging and/or resistive preheating, including but not limited to transformer-rectifiers, inverters, converters, resonant power supplies, quasi-resonant power supplies, switch-mode power supplies, etc., as well as control circuitry and other ancillary circuitry associated therewith.

As used herein, the term “wearable device” includes any form factor that is designed or intended to be worn by a person (e.g., personal protective equipment such as helmets, face guards, apparel, or the like; personal devices such as head-mounted electronic devices, wrist mounted devices, body-mounted devices, devices worn around the neck, or the like), any form factor that, while not necessarily designed or intended to be worn by a person, may be adapted to be worn by a person (e.g., smartphones, tablet computers, and/or other digital processing devices).

As used herein, the term “port” refers to one or more terminals(s), connector(s), plug(s), and/or any other physical interface(s) for traversal of one or more inputs and/or outputs. Example ports include weld cable connections at which a weld cable is physically attached to a device, an gas hose connector connectors that may make physical and/or electrical connections for input and/or output of electrical signals and/or power, physical force and/or work, fluid, and/or gas.

Disclosed example weld monitoring systems include: a camera having a field of view and configured to capture images of the field of view of the camera; a light source coupled to the camera and configured to project a visible indicator onto an object that is within the field of view of the camera, such that the visible indicator at least partially overlaps the field of view of the camera; and communication circuitry configured to transmit data representative of the images.

In some example weld monitoring systems, the visible indicator comprises at least one of a visible laser beam or a visible focused light beam. In some example weld monitoring systems, the camera and the light source are mounted to a welding helmet. In some example weld monitoring systems, the camera and the light source have adjustable angles with respect to the welding helmet.

In some example weld monitoring systems, the visible indicator indicates a location of the field of view of the camera. In some example weld monitoring systems, the visible indicator indicates a boundary of the field of view of the camera. In some example weld monitoring systems, the visible indicator indicates a focal distance with respect to the object.

Some example weld monitoring systems further include a light filter configured to filter arc light, and to pass the filtered arc light to the camera. Some example weld monitoring systems further include a distance sensor configured to measure a distance between the camera and the object illuminated by the visible indicator, wherein the camera is configured to automatically focus based on the distance.

In some example weld monitoring systems, the camera and the light source are mounted to a standalone housing. In some example weld monitoring systems, the camera is configured to capture images of a welding arc. In some example weld monitoring systems, the visible indicator is observable through a welding lens.

Other disclosed example weld monitoring systems include: a camera having a field of view and configured to capture images of the field of view of the camera; a distance sensor configured to measure a distance between the camera and an object within the field of view of the camera; and communication circuitry configured to transmit data representative of the images and representative of the measured distance.

In some example weld monitoring systems, the distance sensor includes a time-of-flight (ToF) sensor. Some example weld monitoring systems further include a computing system configured to receive the data and to calculate one or more operator performance metrics of a welding operation based on the image and the measured distance represented in the data. In some example weld monitoring systems, the communication circuitry is configured to transmit the data wirelessly.

Some example weld monitoring systems further include control circuitry coupled to the camera and the distance sensor, in which the control circuitry is configured to control the camera to adjust a focus of the camera based on the distance sensor. Some example weld monitoring systems further include a light source coupled to the camera and configured to output a visible indicator, in which a measurement location of the distance sensor and the visible indicator are within the field of view of the camera.

In some example weld monitoring systems, the control circuitry is configured to adjust the focus of the camera based on the visible indicator within the images. In some example weld monitoring systems, the camera and the light source are mounted to a welding helmet.

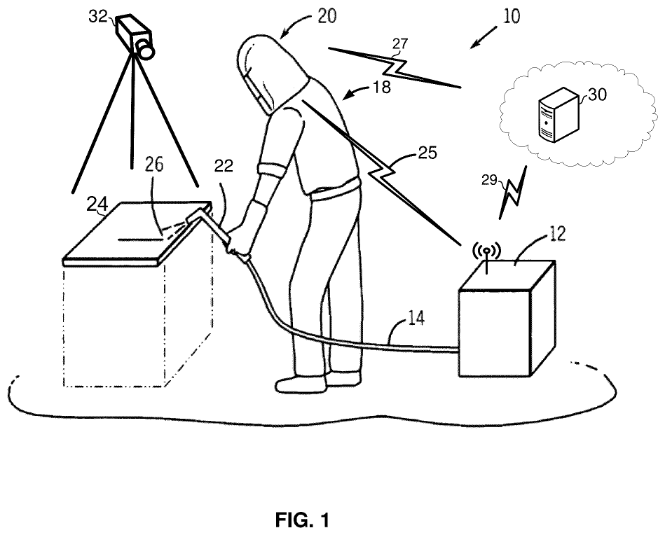

Referring to FIG. 1, there is shown an example welding system 10 in which an operator 18 is wearing welding headwear 20 and welding a workpiece 24 using a torch 22 to which power or fuel is delivered by equipment 12 via a conduit 14. The equipment 12 may comprise a power or fuel source, optionally a source of a shield gas and, where wire/filler material is to be provided automatically, a wire feeder. The welding or cutting system 10 of FIG. 1 may be configured to form a weld joint by any known technique, including flame welding techniques such as oxy-fuel welding and electric welding techniques such as shielded metal arc welding (i.e., stick welding), metal inert gas welding (MIG), tungsten inert gas welding (TIG), and plasma cutting.

Optionally in any embodiment, the welding equipment 12 may be arc welding equipment that provides a direct current (DC) or alternating current (AC) to a consumable or non-consumable electrode 16 of the torch 22. The electrode 16 delivers the current to the point of welding on the workpiece 24. In the welding system 10, the operator 18 controls the location and operation of the electrode 16 by manipulating the torch 22 and triggering the starting and stopping of the current flow. When current is flowing, an arc 26 is developed between the electrode and the workpiece 24. The conduit 14 and the electrode 16 thus deliver current and voltage sufficient to create the electric arc 26 between the electrode 16 and the workpiece. The arc 26 locally melts the workpiece 24 and welding wire or rod supplied to the weld joint (the electrode 16 in the case of a consumable electrode or an optionally separate wire or rod in the case of a non-consumable electrode) at the point of welding between electrode 16 and the workpiece 24, thereby forming a weld joint when the metal cools.

The equipment 12 and headwear 20 may communicate via a link 25. Such communications may enable the headwear 20 to control settings of the equipment 12 and/or the equipment 12 to provide information about its settings to the headwear 20. Although a wireless link is shown, the link may be wireless, wired, or optical.

The external computing device 30 and headwear 20 may communicate directly or indirectly. For the former, the external computing device 30 and headwear 20 may communicate via a link 27. Indirect communications may comprise, for example, the headwear 20 sending time-stamped images and/or other data to the equipment 12 via link 25, where the equipment 12 combines the images and/or data with data of its own and then relays the combined data to external computing device 30 via link 29. Similarly, the external computing device 30 and equipment 12 may communicate directly or indirectly. For the former, the external computing device 30 and equipment 12 may communicate via a link 25. Indirect communications may comprise, for example, the equipment 12 sending time-stamped data to the headwear 20 via link 25, and the headwear 20 combining the data with images and/or data it captures and then relaying the combined data to external computing device 30 via link 27. Another example is to reduce the real time data traffic on link 25 during welding while maintaining the synchronization of video captured by the headwear 20 and the equipment 12. For example, upon a trigger pull by operator at 22, the equipment 12 sends a start sync command to headwear 20 via link 25. Thereafter, the headwear 20 records video or images with timestamp initiated by the start sync command, and the equipment 12 also records welding data initiated by the same start sync command independently of the headwear 20. Upon trigger release or completion of welding, the headwear 20 uploads the time-stamped video or images to the external computing device 30 via the communication link 27, and the equipment uploads the time-stamped weld data to the external computing device 30 via the communication link 29. The external computing device 30 combines the video data and weld data together with a common timestamp that allows playback of both data in synchronization.

The links 25, 27, and 29 may use any suitable protocols such as Bluetooth, Bluetooth Low Energy, WiFi, Zigbee, and/or the like.

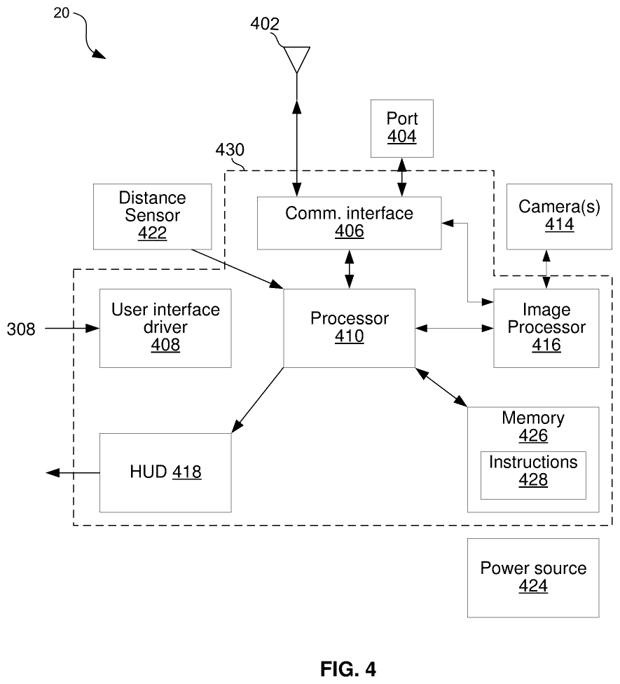

The external computing device 30 may be, for example, a local or remote/cloud workstation(s) or server(s) in a data center. For example, the headwear 20 may transmit images and/or other data (e.g., arc length, temperature, etc.) captured by the headwear 20 to the external computing device 30 for real-time interaction (e.g., viewing, annotating etc.) and/or analysis (e.g., parameters of the torch, workpiece, and/or arc). As another example, the headwear 20 may transmit images and/or other data captured by the headwear 20 to the external computing device 30 for recording/storing for later interaction and/or analysis. As another example, the external computing device 30 may transmit information (e.g., visual and/or audio instructions to adjust various parameters) to the headwear 20 based on analysis of the image and/or other data received from the headwear 20. In an example implementation the external computing device 30 is a component of a welder training system where the welding operator 18 motion is tracked by one or more externally-mounted cameras 32. During a training exercise, the operator 18 motion can be captured together with the video captured by camera(s) of the headwear 20 (e.g., camera(s) 414 of FIG. 4) for synchronized playback at the external computing device 30. One example use of external computing device 30 is for the purpose of quality control. During production welding, the equipment 12 captures the welding signals data while the headwear 20 captures video data representative of what the operator sees. Both data are transmitted to external computing device 30. Due to the large storage demand of video data, external computing device 30 may be a remote server which may more conveniently provide large amounts of storage and/or processing capability than a local server. When a defect is found, both the welding signal data and video data are retrieved from the remote external computing device 30 for playback and failure analysis. Although a wireless link is shown, the link may be wireless, wired, or optical.

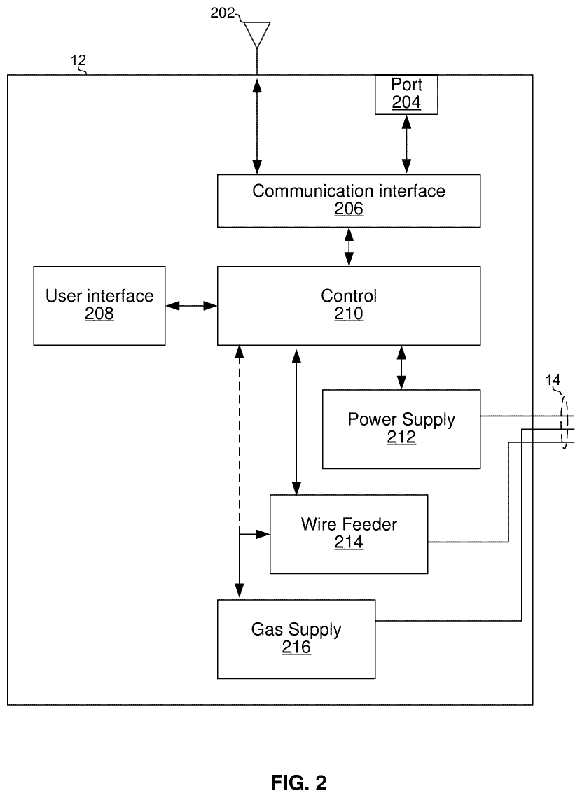

FIG. 2 shows example welding equipment in accordance with aspects of this disclosure. The equipment 12 of FIG. 2 comprises an antenna 202, a communication port 204, a communication interface 206, user interface module 208, control circuitry 210, power supply circuitry 212, wire feeder module 214, and gas supply module 216.

The antenna 202 may be any type of antenna suited for the radio frequencies, power levels, etc. used by the communication link 25.

The communication port 204 may comprise, for example, an Ethernet port, a USB port, an HDMI port, a fiber-optic communications port, and/or any other suitable port for interfacing with a wired or optical cable.

The communication interface 206 is operable to interface the control circuitry 210 to the antenna 202 and/or port 204 for transmit and receive operations. For transmit, the communication interface 206 may receive data from the control circuitry 210 and packetize the data and convert the data to physical layer signals in accordance with protocols in use on the communication link 25. For receive, the communication interface may receive physical layer signals via the antenna 202 or port 204, recover data from the received physical layer signals (demodulate, decode, etc.), and provide the data to control circuitry 210.

The user interface module 208 may comprise electromechanical interface components (e.g., screen, speakers, microphone, buttons, touchscreen, gesture recognition etc.) and associated drive circuitry. The user interface 208 may generate electrical signals in response to user input (e.g., screen touches, button presses, voice commands, gesture recognition etc.). Driver circuitry of the user interface module 208 may condition (e.g., amplify, digitize, etc.) the signals and provide them to the control circuitry 210. The user interface 208 may generate audible, visual, and/or tactile output (e.g., via speakers, a display, and/or motors/actuators/servos/etc.) in response to signals from the control circuitry 210.

The control circuitry 210 comprises circuitry (e.g., a microcontroller and memory) operable to process data from, and/or output data and/or control signals to, the communication interface 206, from the user interface 208, from the power supply circuitry 212, from the wire feeder 214, and/or from the gas supply 216.

The power supply circuitry 212 comprises circuitry for generating power to be delivered to a welding electrode via conduit 14. The power supply circuitry 212 may comprise, for example, one or more switch mode power supplies, buck converters, inverters, and/or the like. The voltage and/or current output by the power supply circuitry 212 may be controlled by a control signal from the control circuitry 210. The power supply circuitry 212 may also comprise circuitry for sensing and reporting the actual current and/or voltage feedback to the control circuitry 210. In an example implementation, the power supply circuitry 212 may comprise circuitry for measuring the voltage and/or current on the conduit 14 (at either or both ends of the conduit 14) such that reported voltage and/or current is actual and not simply an expected value based on calibration.

The wire feeder module 214 is configured to deliver a consumable wire electrode 16 to the weld torch 22 for delivery to a weld joint. The wire feeder 214 may comprise, for example, a spool for holding the wire, an wire feeder for pulling wire off the spool to deliver to the weld torch 22, and circuitry for controlling the rate at which the wire feeder delivers the wire. The wire feeder may be controlled based on a control signal from the control circuitry 210. The wire feeder module 214 may also comprise circuitry for reporting the actual wire speed and/or amount of wire remaining to the control circuitry 210. In an example implementation, the wire feeder module 214 may comprise circuitry and/or mechanical components for measuring the wire speed, such that reported speed is actual speed and not simply an expected value based on calibration.

The gas supply module 216 is configured to provide shielding gas via conduit 14 for use during the welding process. The gas supply module 216 may comprise an electrically controlled valve for controlling the gas on/off. The valve may be controlled by a control signal from control circuitry 210 (which may be routed through the wire feeder 214 or come directly from the control circuitry 210 as indicated by the dashed line). The gas supply module 216 may also comprise circuitry for reporting the present gas flow rate to the control circuitry 210. In an example implementation, the gas supply module 216 may comprise circuitry and/or mechanical components for measuring the gas flow rate such that reported flow rate is actual and not simply an expected value based on calibration.

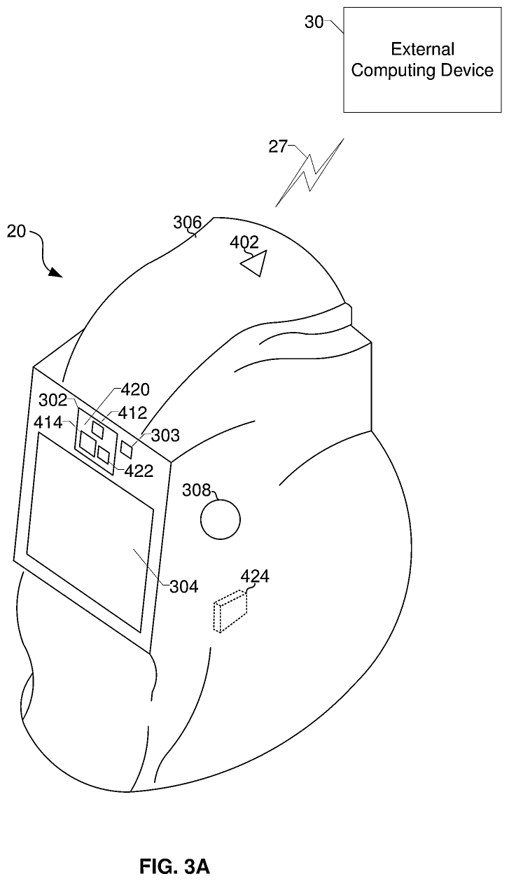

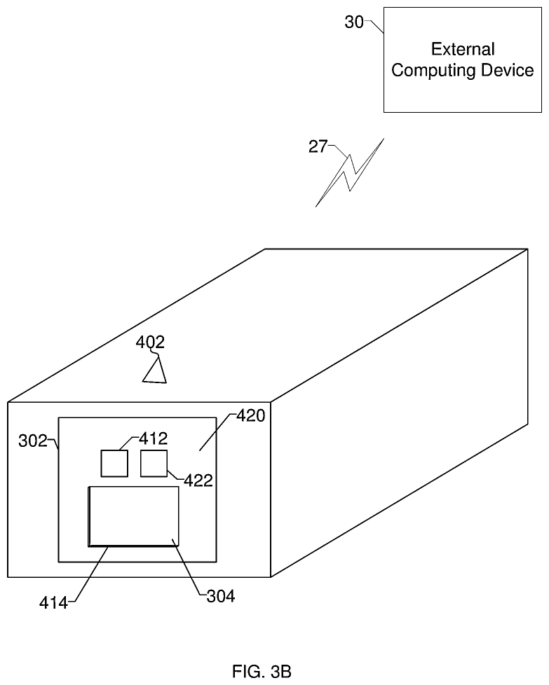

FIG. 3A illustrates an example welding headwear 300 that may implement the welding headwear 20 of FIG. 1 to record a weld. FIG. 3B illustrates an example welding camera 350 that may implement the camera(s) 32 of FIG. 1 to record a weld. FIG. 4 is a block diagram of an example implementation of the example welding headwear 300 and/or the example welding camera 650 of FIGS. 3A and 3B.

The example headwear 20 of FIG. 3A is a helmet comprising a shell 306 in or to which are mounted: one or more cameras 414 comprising optical components 302, lights 303, one or more filter(s) 304, electromechanical user interface components 308, an antenna 402, a communication port 404, a communication circuitry 406, user interface driver 408, a central processing unit (CPU) 410, an image processor 416, a distance sensor 422, a power source 424, and a memory 426. The example memory 426 of FIG. 4 stores machine-readable instructions 428 which may be executed by the processor 410 to implement the examples disclosed herein. In other embodiments, rather than a helmet, the headwear may be, for example, a mask, glasses, goggles, attachment for a mask, attachment for glasses, or attachment for goggles, etc. In the example of FIG. 3B, the camera(s) 414 are mounted to a separate welding monitoring camera 350. The components of the headwear 20 may reside on one or more printed circuit boards (PCBs) or flex circuits. In the example shown merely as one illustration, the power source 424, camera(s) 414, antenna 402, port 404, filter 304, and/or controls 308 are realized as subsystems (e.g., implemented on separate PCBs) apart from/coupled to the PCB 430 while the communications circuitry 406, the user interface driver 408, the processor 410, and/or the memory 426 reside on PCB 430.

Each set of optics 302 may comprise, for example, one or more lenses, filters, and/or other optical components for capturing electromagnetic waves in the spectrum ranging from, for example, infrared to ultraviolet. In an example implementation, the optics 302 may include separate sets of optics for two or more cameras to capture stereoscopic images. Stereoscopic systems calculate the dimensions of the field of view based on the four corners of the image. For example, a stereoscopic system calculates the real-world coordinates of the image points based on a pre-determined spacing between the cameras or optical sensors, and calculates the real-world distance between the points.

The light 303 (e.g., one or more bulbs, LEDs, and/or other light source types) may be located adjacent the camera 414 to illuminate the object(s) being recorded by the camera 414. The light 303 may be affixed to the camera 414 such that changes in orientation or position of the camera 414 changes the orientation or position of the light 303. In some examples, the focus of the light 303 may be adjustable between a narrower beam and a broader beam, using optical focusing elements and/or by controlling which of multiple lights 303 is turned on.

In one example, the camera 414 has a high dynamic range (HDR), a medium dynamic range, or a wide dynamic range (WDR) imaging array that has logarithmic response at each pixel in a single frame time, with a dynamic range exceeding 120 dB to >140 dB. Example techniques to capture images of a weld scene using high dynamic range, wide dynamic range, and the like, are disclosed in U.S. patent application Ser. No. 14/978,141, filed Dec. 22, 2015, and entitled “Automated Welding Translation Platform.” The entirety of U.S. patent application Ser. No. 14/978,141 is incorporated herein by reference. The log response imager allows viewing a typical arc high contrast welding scene with a mix of high intensity arc light and low light surroundings such as joint, weld puddle, electrode extension etc. without saturating the sensor, and suppresses the spatial-temporal light accommodation. The log response imager is effective to auto-balance the exposure and view details such as weld pool surface and a joint seam near the bright arc. The sensors can be CMOS for visible wavelengths for example light reflected by the joint, the contact tip, the electrode etc., or InGaAs for short wave infrared wavelength for example emitted by solidifying weld pool. The imager can be monochrome or color.

In yet another example, the camera 414 can have imaging array that has multiple responses or exposure times at each pixel in a single frame time to extend dynamic range for the high contrast problem of viewing a welding scene. For example, the pixels associated with the bright arc could have a fraction of the exposure time than the pixels in the surrounding scene so that the charging of the pixels is slowed down to avoid saturation.

In yet another example, the camera 414 is a high speed camera with frame rate exceeding 500 to 1000 frames per second or substantially faster than the metal transfer and weld pool oscillation dynamics to avoid aliasing. The camera has CMOS pixel array with high photoresponsivity achieved by short picosecond integration time, synchronous exposure, and high speed parallel read out, and other techniques. The preferred frame rate is at least 10× of the weld physics dynamics which is typically between 50 Hz to 250 Hz. To reduce video file size, high frame rate image acquisition (such as 2 KHz, 10 KHz or higher) can be done in burst mode at fixed intervals or upon sync trigger from the equipment 12 to capture specific metal droplet transfer or weld pool oscillation event.

In yet another example, the camera 414 contains a combined technology of the ones above, for example, a combined high dynamic range and high frame rate imaging, a stereo vision with two HDR imaging, a combined HDR imaging, and a time-of-flight (ToF) imaging.

The electromechanical user interface components 308 may comprise, for example, one or more touchscreen elements, speakers, microphones, physical buttons, gesture control, EEG mind control, etc. that generate electric signals in response to user input. For example, electromechanical user interface components 308 may comprise capacity, inductive, or resistive touchscreen sensors.

The antenna 402 may be any type of antenna suited for the radio frequencies, power levels, etc. used by the communication link 25.

The communication port 404 may comprise, for example, an Ethernet port, a USB port, an HDMI port, a fiber-optic communications port, and/or any other suitable port for interfacing with a wired or optical cable.

The communication circuitry 406 is operable to interface the processor 410 to the antenna 202 and port 204 for transmit and receive operations. For transmit operations, the communication circuitry 406 may receive data from the processor 410 and packetize the data and convert the data to physical layer signals in accordance with protocols in use on the communication link 25. The data to be transmitted may comprise, for example, control signals for controlling the equipment 12. For receive operations, the communication interface may receive physical layer signals via the antenna 202 or port 204, recover data from the received physical layer signals (demodulate, decode, etc.), and provide the data to processor 410. The received data may include indications of present settings and/or actual measured output of the equipment 12, such as voltage, amperage, and/or wire speed settings and/or measurements.

In some examples, the communications circuitry 406 includes a wireless (e.g., Zigbee) coordinator that receives a notification of a trigger pull event and sends the signal to the processor 410 (e.g., a wireless node). In response, the processor 410 enables a WiFi radio of the communications interface to enable transmission of media (e.g., video and/or audio) via higher-bandwidth protocols such as FTP, HTTP, and/or any other protocol.

In some examples, the headwear 20 or camera 32 (e.g., via the processor 410 and the communications circuitry 406) provide media (e.g., video, audio, welding data) to one or more cloud servers to store and/or process the media. In some examples, the headwear 20 accesses the external computing device 30 (e.g., a server or other computing device on a local network, a remote network, a cloud network, etc.) to store, process, measure, and/and control the image data. The external computing device 30 may be implemented by one or more devices external to the headwear 20 via edge and/or peer-to-peer networking. In some examples, the headwear 20 stores the media in a local flash memory and/or other nonvolatile memory inside the helmet (e.g., in the memory 426). The headwear 20 may implement HTTP and/or FTP servers to enable data transfer.

In some examples, the headwear 20 transmits data representative of live (e.g., real-time) video captured by the camera 414 on the headwear 20 to a smart phone and/or the external computing device 30 within wireless communication proximity using peer-to-peer networking (also referred to as point-to-point networking). The transmission of video enables others to view the welding scene even when those people do not have the ability to directly view the weld scene (e.g., the weld arc) due to physical constraints in and/or surrounding the weld scene. In some examples, the headwear 20 includes an RTSP server, and a smart phone app and/or computing device in communication with the helmet includes an RTSP client. The headwear 20 RTSP server uses the Real-time Transport Protocol (RTP) in conjunction with Real-time Control Protocol (RTCP) for media stream delivery.

The user interface driver 408 is operable to condition (e.g., amplify, digitize, etc.) signals from the user interface component(s) 308.

The processor 410 processes data from the communication circuitry 406, the user interface driver 408, and/or the image processor 416, and to generate control and/or data signals to be output to the communication circuitry 406. Signals output to the communication circuitry 406 may comprise, for example, signals to control settings of equipment 12. Such signals may be generated based on signals from the user interface driver 408. Signals from the communication circuitry 406 may comprise, for example, indications (received via link 25) of present settings and/or actual measured output of the equipment 12.

The one or more cameras 414 are operable to capture images of a field of view in the vicinity of the headwear 20 or camera 32. The camera 414 may have a fixed or adjustable position and/or angle with respect to the shell 306 of the headwear 20 or the shell 356 of the camera 32. For example, an operator may be able to loosen a bracket or other mounting hardware to adjust an angle and/or position of the camera 414, and then secure the bracket or other hardware to secure the angle and/or position of the camera 414.

A light source 412 is coupled to the camera 414, and projects a visible indicator onto an object that is within the field of view of the camera 414. For example, the visible indicator may be a laser point, a light beam, a projected graphic, a projected box or grid identifying an approximate boundary of the field of view of the camera 414, and/or any other visible indicator. In some examples, the light source 412 projects an indicator that is observable through a welding lens (e.g., through an auto-darkening filter that is activated).

The visible indicator may indicate the location of the field of view of the camera 414 and/or a focal distance of the camera 414. The visible indicator is generally smaller than or equal to the field of view of the camera 414. The light source 412 may be rigidly coupled to the shell such that, as the position and/or angle of the camera 414 is adjusted with respect to the shell 306, the position and/or angle of the light source 412 is similarly changed to maintain the visible indicator within the field of view of the camera 414.

The light source 412 may be activated and/or deactivated using an input device, such as a button. For example, the light source 412 may be activated via a first button, voice command, and/or any other input to the welding headwear 20 or external camera(s) 32, and deactivated via a second button, voice command, and/or any other input, and/or via a timeout.

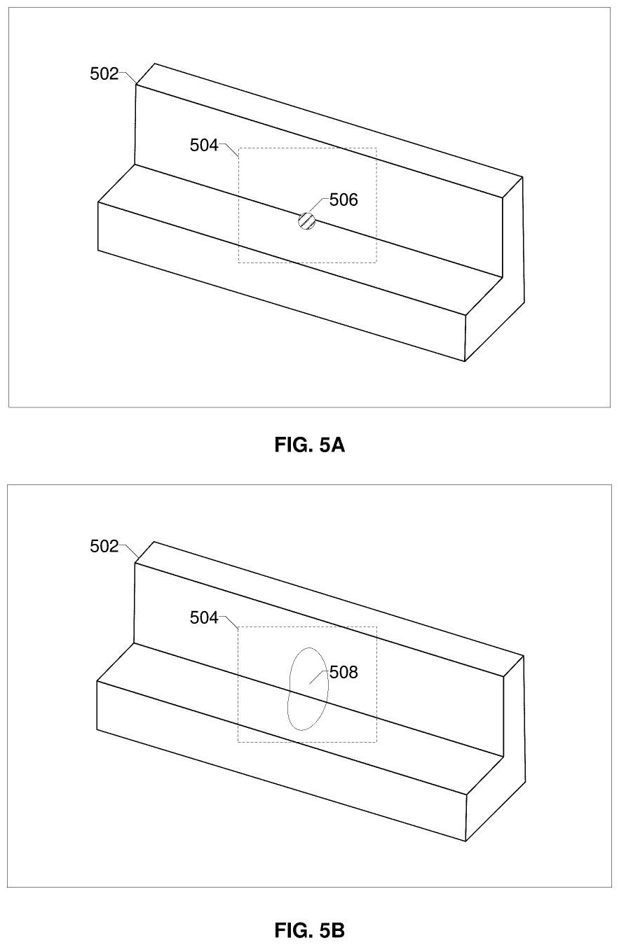

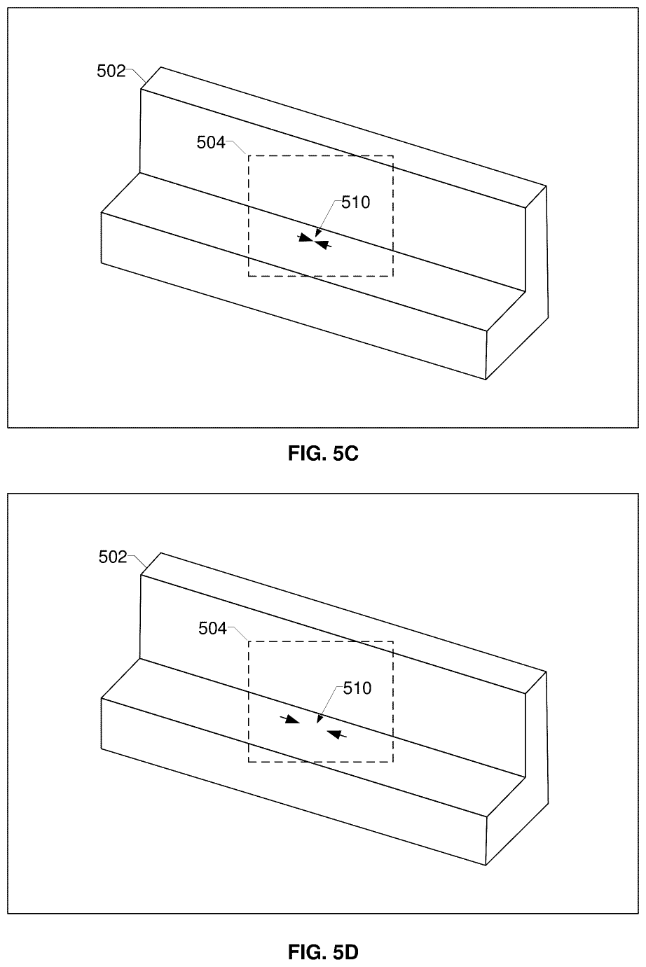

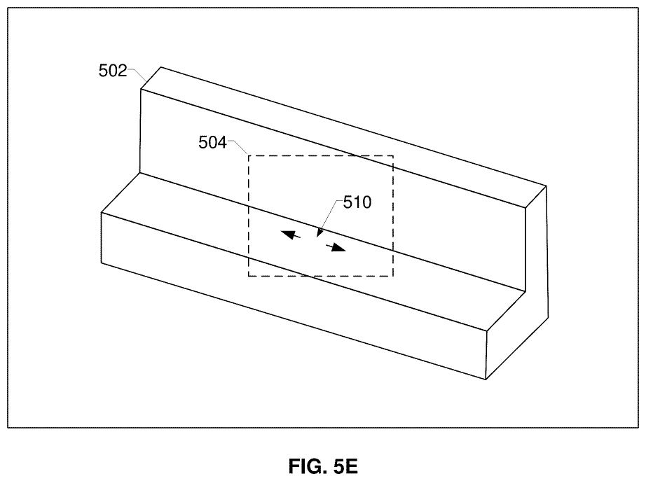

FIG. 5A illustrates an example object (e.g., a welding workpiece 502) within the field of view 504 of the camera 414. As illustrated in FIG. 5A, a visible laser point indicator 506 is projected onto the welding workpiece 502 to indicate the location of the field of view of the camera 414. As the welding headwear 20 is moved and/or re-oriented, the visible laser point indicator 506 also moves to indicate the location of the field of view.

FIG. 5B illustrates the example welding workpiece 502 within the field of view of the camera 414, and including a visible light beam indicator 508 of the field of view of the camera 414. The visible light beam indicator 508 is larger than the laser point indicator 506, and may be focused to increase or decrease the size of the visible light beam indicator 508.

FIGS. 5C-5E illustrate the example welding workpiece 502 within the field of view of the camera 414, and including a visible graphical indicator 510 that indicates both the location of the field of view and a focal distance of the camera 414. To generate the visible graphical indicator 510, the light source 412 may include two light sources that generate different portions of the graphical indicator 510 (e.g., different arrow graphics in FIGS. 5C-5E). As the projection distance between the light source 412 and the workpiece 502 changes, the different projection angles cause the graphics to change respective positions.

In the example of FIG. 5C, the graphical indicator 510 indicates that the focal distance of the camera 414 is approximately even with the surface on which the graphical indicator 510 is visible. In FIG. 5D, the graphical indicator 510 indicates that the focal distance of the camera 414 is shorter than the distance from the camera 414 to the surface on which the graphical indicator 510 is visible. In FIG. 5E, the graphical indicator 510 indicates that the focal distance of the camera 414 is longer than the distance from the camera 414 to the surface on which the graphical indicator 510 is visible.

In some examples, the light source 412 is adjustable to compensate for changes in focus of the camera 414. For example, if the focal distance of the camera 414 changed from being longer or shorter than the distance to the surface to being even with the distance to the surface, the light source 412 may be automatically or manually adjusted to move the graphical indicators 510 to the position illustrated in FIG. 5C. Following the adjustment, further changes in distance between the camera 414 and the surface will cause the spacing between the graphical indicators 510 to change accordingly.

Returning to FIG. 4, the welding headwear 20 and/or external camera 32 further includes a distance sensor 422, which measures the distance between the distance sensor 422 and a target surface. In the example of FIGS. 3A, 3B, and 4, the distance sensor 422 is positioned and arranged to measure a distance between the camera 414 and an object within the field of view of the camera 414 (e.g., an object illuminated by the visible indicator). The distance sensor 422 may be a ToF sensor, a LIDAR sensor, an ultrasonic sensor, and/or any other type of distance sensor.

In some examples, the processor 410 performs an automatic focusing of the camera 414 based on the distance measured by the distance sensor 422. For example, the processor 410 may configure the camera 414 to set a focal distance of the camera 414 equal to the distance measured via the distance sensor 422. Additionally or alternatively, the processor 410 may perform an automatic focusing of the camera 414 based on markers placed on the welding torch 22 and/or on the workpiece 24. For example, the processor 410 may automatically focus the camera 414 to achieve the desired image sharpness using the marker, which results in the correct focal distance. The marker may be a predetermined symbol (e.g., a QR code or a graphic), a retroreflective marker, and/or any other type of visible marker.

Any of the camera 414, the light source 412, and/or the distance sensor 422 may be protected by an arc light filter 420 (e.g., part of optics 302) that is configured to attenuate light from the arc and pass filtered light to the camera 414, the light source 412, and/or the distance sensor 422. The optics 302 may include separate arc light filters 420 for each of the camera 414, the light source 412, and/or the distance sensor 422, and/or may use a same arc light filter 420 for two or more of the camera 414, the light source 412, and/or the distance sensor 422.

In some examples, the welding headwear 20 and/or the external camera 32 transmit raw and/or lightly processed image data to the external computing device 30 for further processing and display. By transmitting the raw or lightly processed image data, the computational requirements and/or power requirements present on the welding headwear 20 and/or the external camera 32 are reduced, thereby reducing the weight and/or size of the components installed on the welding headwear 20 and/or the external camera 32. In some examples, to aid in image processing, the processor 410 may control the camera 414 to generate frames having different exposure times (e.g., alternating long and short exposures), and the raw or lightly processed image data from the images of different exposure times can be transmitted.

The camera(s) 414 may be operable to capture electromagnetic waves of any suitable wavelength(s) from, for example, infrared to ultraviolet. In an example implementation, there may be two cameras 414 for capturing stereoscopic images from which 3D positioning information can be obtained through processing of the captured images. The camera(s) 414 may each include one or more high dynamic range image sensors (e.g., ˜140 dB or more of dynamic range), such that a viewer of the image can simultaneously see the weld arc and the workpiece. In some examples, images from multiple image sensors are combined to generate composite images having higher dynamic range than is supported by any of the image sensors alone.

In some examples, the image processor 416 controls the camera 414 to perform optical and/or digital image stabilization. For example, one or more inertial measurement units (IMUs) such as multi-axis gyroscopes, multi-axis accelerometers, and/or multi-axis magnetometers may detect, encode, and/or measure movement of the helmet (e.g., turning, vibration, traveling and shaking of the helmet as the wearer's head moves to follow the arc). Based on the measured movement, the image processor 416 compensates for the motion by moving the lens and/or the imager using, for example, micro actuators and/or microelectromechanical systems (MEMS) such as piezoelectric crystals. Additionally or alternatively, the image processor 416 may implement electronic image stabilization (EIS). By using image stabilization techniques, torch motion data and/or torch angularity data with respect to a welded joint can be extracted from captured images. Such data is potentially beneficial for subsequent training of welders to weld on joints that are difficult or impossible for cameras at a fixed location, such as 360 degree 5G position and/or 6G position pipe welding. Additionally or alternatively, sensors may be included for a fixed-mount camera to track the motion of the helmet and use the helmet position and/or orientation to transform the images captured by the camera 414 in the helmet.

Some example cameras 414 include a high dynamic range imager or image sensor array (e.g., at least 120 dB of dynamic range) and/or native wide dynamic range imager (e.g., at least 140 dB of dynamic range) on the headwear 20. In other examples, a welding system includes a medium dynamic range (MDR) imager with at least 100 dB of dynamic range to decrease the component costs of the helmet. One example MDR imager that may be used is model MT9V024, sold by ON Semiconductor®.

In some examples, the headwear 20 further includes a light source oriented to illuminate the weld scene. The lighting can be an active light source such as an LED array. To conserve battery power of the headwear 20, the light source can be activated automatically when the camera 414 is taking images and determines that additional lighting is beneficial (e.g., luminance received at the camera 414 is less than a threshold). Additionally or alternatively, the active light source can be activated and/or deactivated by an operator interface, such as a voice command. Additionally or alternatively, the headwear 20 may be provided with passive light sources such as a reflective exterior surface. Such a passive light source may reflect energy from the arc to illuminate the welding scene.

The image processor 416 may include an exposure controller that receives arc signals from a power supply or wire feeder (e.g., via a wired or wireless data connection such as the communications circuitry 406) as a feed forward signal to adapt the exposure time for an optical sensor and/or image processing. Specifically, the image processor 416 may use arc voltage to determine the presence and absence of an arc in the scene. If the sensed arc voltage (e.g., excluding the welding cable voltage and/or electrode stickout voltage) is greater than 14V, the image processor 416 determines that an arc is present and, in response, reduces the exposure to reveal the details of the dark areas such as joint and wire extension. The image processor 416 may also use more aggressive image compression ratios and/or digital image filters for the comparatively brighter scenes. In contrast, when the sensed arc voltage is less than 14V, the image processor 416 determines that the arc is absent and the scene is dark. In response to determining that the arc is not present, the image processor 416 uses longer exposures and less aggressive image compression ratios and/or digital image filters.

In some examples, the image processor 416 uses arc power in addition to or instead of the arc signal as a proxy for the brightness of the arc. For example, the image processor 416 may use level of arc voltage or arc current (or the product of voltage and current which is the arc power) to predict the brightness of the scene, thus adjusting exposure and selecting corresponding image processing algorithms and their parameters. Thus, the image processor 416 more effectively adapts to arc starts and/or stops, and/or when using welding processes where the arc brightness changes quickly (e.g., frequencies of 20 Hz to 250 Hz), such as in pulse welding and short circuiting welding.

In an example implementation, the processor 410 receives synchronizing signal(s) which trigger the camera 414 to start and/or stop video recording. The synchronizing signal may be generated by circuitry of the headwear 20 or by circuitry external to the headwear 20. The synchronizing signal may, for example, be: generated by circuitry of the equipment 12 and received via antenna 402; generated by sensor(s) (e.g., a passive IR sensor or photodiode) and communicated to the camera 414 via a wired or wireless interface between the camera 414; or the like. The synchronizing signal may, for example, be in response to: the pull of the gun trigger; a change in the output of a photodiode which captures light intensity of the environment; detection, using image processing algorithms, of a welding arc in an image captured by camera 414; and/or any other suitable stimulus.

The headwear 20 and/or the camera(s) 32 may comprise, for example, infrared and/or ultrasonic sensors, accelerometers, gyroscopes, and/or the like.

The power source 424 may comprise, for example, a battery (e.g., a lithium ion or sodium ion or lithium polymer or dual carbon battery), circuitry for charging the battery from an AC and/or DC power source, and circuitry for conditioning/delivering energy from the battery to the other circuitry of the headwear 20.

In some examples, the camera 414 may capture images using at least one of: recording high dynamic range images, recording high dynamic range video, recording wide dynamic resolution images, recording wide dynamic resolution video, recording time-of-flight images, and/or recording three-dimensional images with a structured light camera having three-dimensional depth perception. In some such examples, capturing images includes using an optical sensor with a logarithmic response. Higher-frame-rate video feeds generated by the camera 414 may require a higher-bandwidth transmission protocol by the communication circuitry 406, and/or may involve temporary storage of all or part of the captured images and subsequent transfer of a fuller set of images for processing and analysis.

In some examples, the welding headwear 20 and/or external camera 32 provides the media to one or more cloud servers to store and/or process the media. In some examples, the helmet accesses a cloud network to store, process, measure and control the image data. The cloud network may be implemented by one or more devices external to the helmet via edge and/or peer-to-peer networking. In some examples, the welding headwear 20 and/or external camera 32 stores the media (e.g., video and/or audio) in a local flash memory and/or other nonvolatile memory inside the helmet. The helmet further implements HTTP and/or FTP servers. In some examples, a smart phone within wireless communication proximity serves as an edge resource fog network by executing an application, an HTTP client, and/or an FTP client. The example smart phone accesses the media stored in the storage device of the helmet. In some examples, the smart phone provides storage, processing, and/or analysis capacities. The weld equipment and/or the smart phone can be edge resources for configuration, pooling, caching and security of videos and audios captured by the helmet.

In some examples, the welding headwear 20 and/or external camera 32 transmits live video captured by a recording device on the helmet to a smart phone and/or computing device within wireless communication proximity using peer-to-peer networking (also referred to as point-to-point networking). The transmission of video enables others to view the welding scene even when those people do not have the ability to directly view the weld scene (e.g., the weld arc) due to physical constraints in and/or surrounding the weld scene. In some examples, the helmet includes an RTSP server, and a smart phone app and/or computing device in communication with the helmet includes an RTSP client. The helmet RTSP server uses the Real-time Transport Protocol (RTP) in conjunction with Real-time Control Protocol (RTCP) for media stream delivery.

In some examples, the camera 414 and/or the processor 410 may perform optical and/or digital image stabilization. The welding headwear 20 and/or external camera 32 may include one or more inertial measurement units (IMUs) such as multi-axis gyroscopes, multi-axis accelerometers, and/or multi-axis magnetometers to detect, encode, and/or measure movement of the helmet (e.g., turning, vibration, traveling and shaking of the helmet as the wearer's head moves to follow the arc). Based on the measured movement, the welding headwear 20 and/or external camera 32 compensates for the motion by moving the lens and/or the imager using, for example, micro actuators and/or microelectromechanical systems (MEMS) such as piezoelectric crystals. Additionally or alternatively, the welding headwear 20 and/or external camera 32 may implement electronic image stabilization (EIS). By using image stabilization techniques, a welder training system, such as LiveArc® sold by Miller Electric™, can use helmet mounted cameras instead of or in addition to fixed-location cameras to extract torch motion data and/or torch angularity data with respect to a welded joint. Such data is potentially beneficial for subsequent training of welders to weld on joints that are difficult or impossible for cameras at a fixed location, such as 360 degree 5G position and/or 6G position pipe welding. Additionally or alternatively, a welding helmet may include sensors for a fixed-mount camera to track the motion of the helmet and use the helmet position and/or orientation to transform the images captured by the camera in the helmet.

In some examples, the headwear 20 may include a heads up display (HUD) 418 or a similar display on an external camera 32, to display information associated with the recording of the camera and/or other information. For example, the processor 410 may display to the wearer, via the HUD 418, information such as a marker indicating the field of view or focal point of the camera 414. The field of view marker may be generated and reflected onto the interior of a the welding headwear, and aimed based on the focal distance of the camera 414 to align the marker HUD 418 with the field of view of the camera 414.

The HUD 418 may be provided with additional data for display (e.g., via the processor 410 and/or the communications interface 306), such as travel speed, contact-tip-to-work distance (CTWD), wire feed speed, voltage, and/or amperage, and/or any other welding parameter data or technique data. Additionally or alternatively, the HUD 418 may display information such as remaining consumables (e.g., welding wire, shielding gas, engine fuel, etc.), and/or service alerts or warnings from the welding equipment.

While example implementations of the headwear 20 are described with reference to FIGS. 3A, 3B, and 4, other implementations may be used. For example, any of the example antenna 402, the example port 404, the example communications circuitry 406, the example user interface driver 408, the example processor 410, the example camera(s) 414, the example image processor 416, the example distance sensor(s) 422, the example power source 424, the example memory 426, and/or the example instructions 428 may be implemented using hardware, software, firmware, and/or any combination of hardware, software, and/or firmware. For example, the example antenna 402, the example port 404, the example communications circuitry 406, the example user interface driver 408, the example processor 410, the example camera(s) 414, the example image processor 416, the example distance sensor(s) 422, the example power source 424, the example memory 426, and/or the example instructions 428 may be implemented using one or more integrated circuits and/or discrete circuits, such as general purpose processors, special purpose processors (e.g., digital signal processors), programmable logic devices. Furthermore, implementations may include combinations of components and/or functions into single integrated circuit packages and/or divisions of components and/or functions into multiple integrated circuit packages.

The example external computing device 30 may perform analyses on the received image and/or distance information. For example, the external computing device 30 may use image processing techniques to measure operator performance metrics of a welding operation based on the image and the measured distance represented in the data. Example operator performance metrics may include arc length, travel angle, work angle, travel speed, and/or aim. The external computing device 30 may report the measured operator performance metrics with a recording of the welding operation, such as for review, traceability, and/or training purposes.

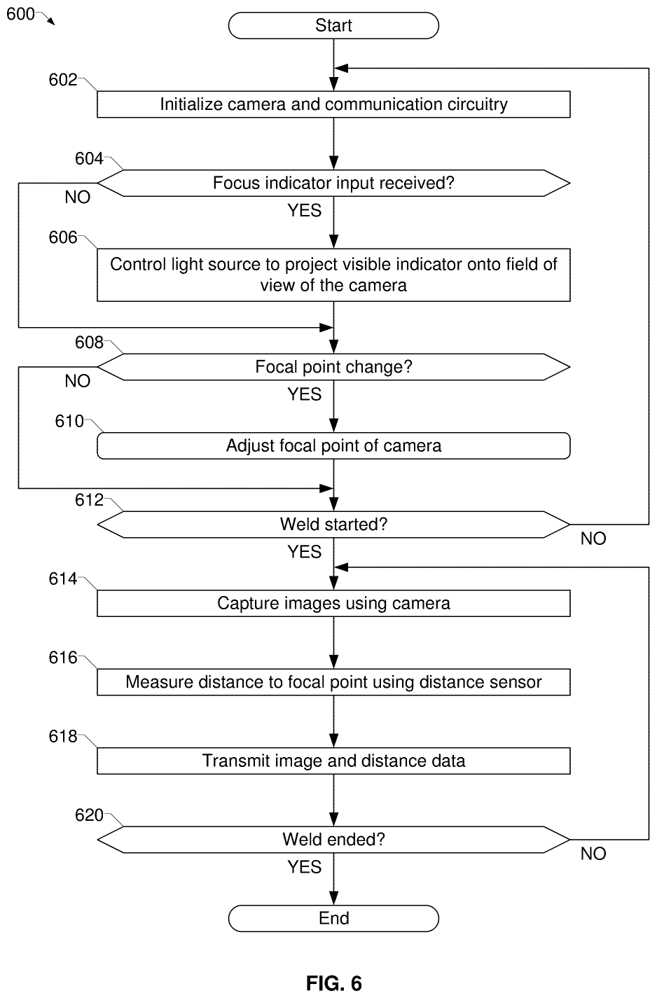

FIG. 6 is a flowchart representative of example machine readable instructions 600 which may be implemented by the welding headwear 20 and/or the welding camera 32 of FIGS. 3A, 3B, and/or 4 to record a welding-type operation using a camera (e.g., the camera 414). The example instructions 600 are described below with reference to the example welding headwear 20 of FIGS. 3A and 4.

At block 602, the processor 410 initializes the camera 414 and the communication circuitry 406. For example, the processor 410 may control the camera 414 to set a focal distance and/or establish communications with one or more external devices (e.g., the equipment 12, the external computing device 30 of FIG. 1) via the communications circuitry 406.

At block 604, the processor 410 determines whether a focus indicator input has been received. For example, the operator may push a focus indicator button on the welding headwear 20, which is received via the user interface driver 408. If a focus indicator input has been received (block 604), at block 606 the processor 410 controls the light source 412 to project a visible indicator onto the field of view of the camera 414. For example, the visible indicator may be a laser beam, a focused light beam, a graphic indicator, and/or any other visible indicator.

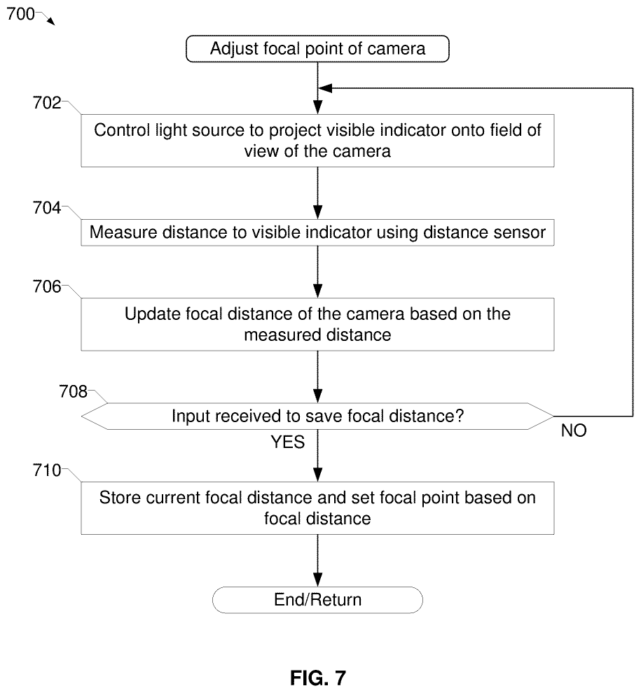

If a focus indicator input has been received (block 604), or after controlling the light source 412 to project the indicator (block 606), at block 608 the processor 410 determines whether the focal point is to change. For example, the operator may select an input button or other device to command the processor 410 to adjust the focal point (and/or focal distance) of the camera 414. If the focal point is to change (block 608), at block 610 the processor 410 adjusts the focal point of the camera 414. Example instructions to implement block 610 are disclosed below with reference to FIG. 7.

After adjusting the focal point (block 610), or if the focal point is not changing (block 608), at block 612 the processor 410 determines whether a weld has started. For example, the processor 410 may receive input from an arc light sensor or auto-darkening filter, a trigger communication from the welding equipment 12, and/or any other indication that the weld has started. If a weld has started (block 612), at block 614 the processor 410 captures images using the camera 414.

At block 616, the distance sensor 422 measures a distance to the focal point of the camera 414. At block 618, the processor 410 transmits the image data (e.g., raw image data) and the distance data. For example, the processor 410 may wirelessly transmit the image and distance data to the external computing device 30 for processing, analysis, and/or storage. In some examples, the processor 410 wirelessly transfers data at intervals, and shuts down the communications interface 406, or portions of the communications interface 406, to conserve power. For example, the processor 410 may temporarily store the image data, and then transfer the image data at a predetermined later time or interval.

At block 620, the processor 410 determines whether the weld has ended. For example, the processor 410 may use the same inputs as determining whether the weld has started (block 612) to determine whether the weld has ended. If the weld has not ended (block 620), control returns to block 614.

When the weld has ended, the example instructions 600 end.

FIG. 7 is a flowchart representative of example machine readable instructions 700 which may be implemented by the welding headwear and/or the welding camera of FIGS. 3A, 3B, and/or 4 to adjust a focal distance of the camera 414. The instructions 700 may implement block 610 of FIG. 6 to adjust the focal point of the camera 414. The example instructions 600 are described below with reference to the example welding headwear 20 of FIGS. 3A and 4.

At block 702, the processor 410 controls the light source 412 to project a visible indicator onto the field of view of the camera 414. For example, the light source 412 may project a laser point or other indicator onto a surface within the field of view of the camera 414. At block 704, the processor 410 measures a distance to the visible indicator (e.g., a surface on which the visible indicator is projected) via the distance sensor 422.

At block 706, the processor 410 updates a focal distance of the camera 414 based on the measured distance. For example, the processor 410 may control the camera 414 to automatically adjust focus, via software and/or hardware, to match the distance measured by the distance sensor 422.

At block 708, the processor 410 determines whether an input has been received to save the focal distance. For example, when the operator has identified the desired surface on which the camera 414 should focus, and the focal distance has been set to the desired surface, the processor 410 may receive an input from the operator (e.g., via the user interface driver 408) to save the set focal distance (e.g., prevent further changes unless requested by the operator). If an input to save the focal distance has not been received (block 708), control returns to block 702 to continue updating the focal distance.

When an input has been received to save the focal distance, the processor 410 stores the current focal distance and sets the focal point of the camera 414 based on the focal distance. For example, the processor 410 may use the current focal distance as a fixed focal distance, and does not change the focal distance from the stored focal distance until another adjustment is requested by the operator.

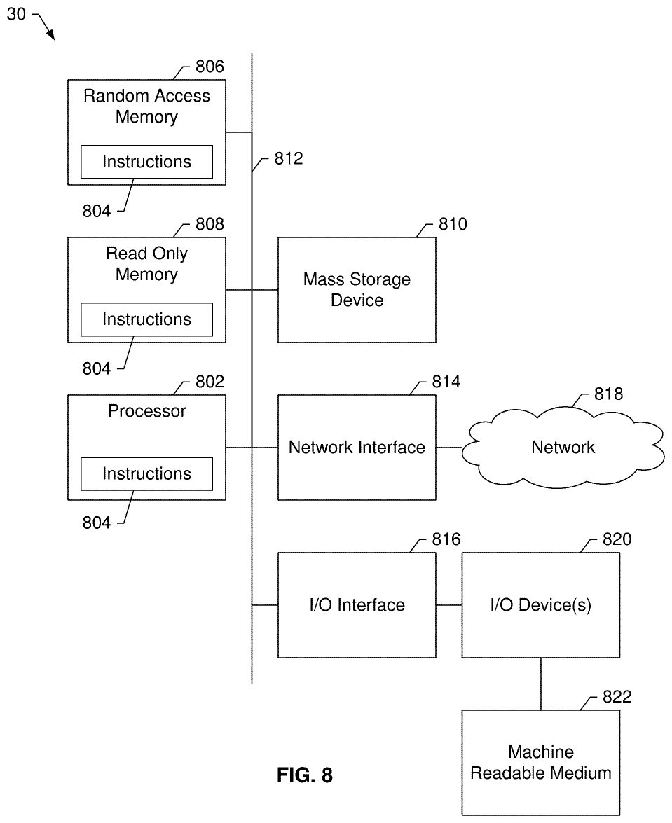

FIG. 8 is a block diagram of an example implementation of the external computing device 30 of FIG. 1. The example external computing device 30 of FIG. 8 may be a general-purpose computer, a laptop computer, a tablet computer, a mobile device, a server, and/or any other type of computing device. In some examples, the external computing device 30 may be implemented in a cloud computing environment using one or more physical machines and, in some examples, one or more virtual machines in the data center.

The example external computing device 30 of FIG. 8 includes a processor 802. The example processor 802 may be any general purpose central processing unit (CPU) from any manufacturer. In some other examples, the processor 802 may include one or more specialized processing units, such as graphic processing units and/or digital signal processors. The processor 802 executes machine readable instructions 804 that may be stored locally at the processor (e.g., in an included cache), in a random access memory 806 (or other volatile memory), in a read only memory 808 (or other non-volatile memory such as FLASH memory), and/or in a mass storage device 810. The example mass storage device 810 may be a hard drive, a solid state storage drive, a hybrid drive, a RAID array, and/or any other mass data storage device.

A bus 812 enables communications between the processor 802, the RAM 806, the ROM 808, the mass storage device 810, a network interface 814, and/or an input/output interface 816.

The example network interface 814 includes hardware, firmware, and/or software to connect the external computing device 30 to a communications network 818 such as the Internet. For example, the network interface 814 may include IEEE 802.X-compliant wireless and/or wired communications hardware for transmitting and/or receiving communications.

The example I/O interface 816 of FIG. 8 includes hardware, firmware, and/or software to connect one or more input/output devices 820 to the processor 802 for providing input to the processor 802 and/or providing output from the processor 802. For example, the I/O interface 816 may include a graphics processing unit for interfacing with a display device, a universal serial bus port for interfacing with one or more USB-compliant devices, a FireWire, a field bus, and/or any other type of interface. Example I/O device(s) 820 may include a keyboard, a keypad, a mouse, a trackball, a pointing device, a microphone, an audio speaker, a display device, an optical media drive, a multi-touch touch screen, a gesture recognition interface, a magnetic media drive, and/or any other type of input and/or output device.

The example external computing device 30 may access a non-transitory machine readable medium 822 via the I/O interface 816 and/or the I/O device(s) 820. Examples of the machine readable medium 822 of FIG. 8 include optical discs (e.g., compact discs (CDs), digital versatile/video discs (DVDs), Blu-ray discs, etc.), magnetic media (e.g., floppy disks), portable storage media (e.g., portable flash drives, secure digital (SD) cards, etc.), and/or any other type of removable and/or installed machine readable media.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

The present devices and/or methods may be realized in hardware, software, or a combination of hardware and software. The present methods and/or systems may be realized in a centralized fashion in at least one computing system, processors, and/or other logic circuits, or in a distributed fashion where different elements are spread across several interconnected computing systems, processors, and/or other logic circuits. Any kind of computing system or other apparatus adapted for carrying out the methods described herein is suited. A typical combination of hardware and software may be a processing system integrated into a welding power supply with a program or other code that, when being loaded and executed, controls the welding power supply such that it carries out the methods described herein. Another typical implementation may comprise an application specific integrated circuit or chip such as field programmable gate arrays (FPGAs), a programmable logic device (PLD) or complex programmable logic device (CPLD), and/or a system-on-a-chip (SoC). Some implementations may comprise a non-transitory machine-readable (e.g., computer readable) medium (e.g., FLASH memory, optical disk, magnetic storage disk, or the like) having stored thereon one or more lines of code executable by a machine, thereby causing the machine to perform processes as described herein. As used herein, the term “non-transitory machine readable medium” is defined to include all types of machine readable storage media and to exclude propagating signals.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A weld monitoring system, comprising:
a camera having a field of view and configured to capture images of the field of view of the camera;
a light source coupled to the camera and configured to project a visible indicator onto an object that is within the field of view of the camera, such that the visible indicator at least partially overlaps the field of view of the camera; and
communication circuitry configured to transmit data representative of the images.

2. The weld monitoring system as defined in claim 1, wherein the visible indicator comprises at least one of a visible laser beam or a visible focused light beam.

3. The weld monitoring system as defined in claim 1, wherein the camera and the light source are mounted to a welding helmet.

4. The weld monitoring system as defined in claim 3, wherein the camera and the light source have adjustable angles with respect to the welding helmet.

5. The weld monitoring system as defined in claim 1, wherein the visible indicator indicates a location of the field of view of the camera.

6. The weld monitoring system as defined in claim 5, wherein the visible indicator indicates a boundary of the field of view of the camera.

7. The weld monitoring system as defined in claim 5, wherein the visible indicator indicates a focal distance with respect to the object.

8. The weld monitoring system as defined in claim 1, further comprising a light filter configured to filter arc light, and to pass the filtered arc light to the camera.

9. The weld monitoring system as defined in claim 1, further comprising a distance sensor configured to measure a distance between the camera and the object illuminated by the visible indicator, wherein the camera is configured to automatically focus based on the distance.

10. The weld monitoring system as defined in claim 1, wherein the camera and the light source are mounted to a standalone housing.

11. The weld monitoring system as defined in claim 1, wherein the camera is configured to capture images of a welding arc.

12. The weld monitoring system as defined in claim 1, wherein the visible indicator is observable through a welding lens.

13. A weld monitoring system, comprising:
a camera having a field of view and configured to capture images of the field of view of the camera;
a distance sensor configured to measure a distance between the camera and an object within the field of view of the camera; and
communication circuitry configured to transmit data representative of the images and representative of the measured distance.

14. The weld monitoring system as defined in claim 13, wherein the distance sensor comprises a time-of-flight (ToF) sensor.

15. The weld monitoring system as defined in claim 13, further comprising a computing system configured to receive the data and to calculate one or more operator performance metrics of a welding operation based on the image and the measured distance represented in the data.

16. The weld monitoring system as defined in claim 15, wherein the communication circuitry is configured to transmit the data wirelessly.

17. The weld monitoring system as defined in claim 13, further comprising control circuitry coupled to the camera and the distance sensor, where the control circuitry is configured to control the camera to adjust a focus of the camera based on the distance sensor.

18. The weld monitoring system as defined in claim 17, further comprising a light source coupled to the camera and configured to output a visible indicator, wherein a measurement location of the distance sensor and the visible indicator are within the field of view of the camera.

19. The weld monitoring system as defined in claim 18, wherein the control circuitry is configured to adjust the focus of the camera based on the visible indicator within the images.

20. The weld monitoring system as defined in claim 13, wherein the camera and the light source are mounted to a welding helmet.
